(19) United States
(12) Patent Application Publication
(10) Pub. No.: US 2016/0140748 A1
(43) Pub. Date: May 19, 2016

(54) AUTOMATED ANIMATION FOR PRESENTATION OF IMAGES

(71) Applicant: Lytro, Inc., Mountain View, CA (US)

(72) Inventors: Bryan Cline, Oakland, CA (US); Jiangtao Kuang, Sunnyvale, CA (US)

(21) Appl. No.: 14/938,796

(22) Filed: Nov. 11, 2015

Related U.S. Application Data
(60) Provisional application No. 62/080,191, filed on Nov. 14, 2014.

(51) Int. Cl. G06T 13/80; G06T 7/40; G06T 3/20; G06K 9/00; G06T 7/00; G06T 11/00; G06K 9/46

(52) U.S. Cl. CPC G06T 13/80; G06T 11/001; G06T 7/408; G06K 9/4652; G06K 9/00302; G06K 9/0061; G06T 7/0051; G06T 3/20

(57) ABSTRACT

An image such as a light-field image may be displayed dynamically through the use of an automatically generated animation. The image may be received in a data store. One or more attributes of the image may be automatically evaluated. Based on the one or more attributes, a first animation parameter may be selected. An animation of the image may be automatically generated such that the animation possesses the first animation parameter. On a display device, the animation may be displayed. The one or more attributes may optionally include coloration of the image, presence of a computer-recognizable feature in the image, presence of a computer-recognizable human face in the image, a gaze direction of a person appearing in the image, and/or a depth, relative to the camera, of an object appearing in the image.

### CROSS-REFERENCE TO RELATED APPLICATIONS

The present application claims the benefit of U.S. Provisional Application Ser. No. 62/080,191 for “Automated Animation for Presentation of Light-Field Images” (Atty. Docket No. LYT170-PROV), filed Nov. 14, 2014, the disclosure of which is incorporated herein by reference in its entirety.

### TECHNICAL FIELD

The present document relates to dynamic, animated presentation of images such as light-field images.

### BACKGROUND

When presenting images, such as still two-dimensional (2D) images, it is often effective to animate the presentation by changing the position, focus, zoom level, orientation, and/or other parameters, in a dynamic fashion while the image is being displayed. Such animations often achieve a more compelling image viewing experience than would a static presentation of the imagery.

Various techniques can be applied to images, such as shift and pan effects made popular by Ken Burns, the well-known director of documentary films. In general, animations are authored by manual interaction of designers. The designers adjust the attributes of the animations, such as focus point, perspective, speed, and/or the like, based on the effect desired and taking into account image contents and emotion of the scene. This can be a laborious process.

Some systems zoom and/or pan automatically, for example when presenting images in a screen saver, or when generating montages. However, these systems generally do not take image content into account, but instead apply basic, random or predefined zooms and/or pans without regard to image content.

### SUMMARY

The present document describes a method for automatically generating animations for images, such as light-field images, based on their specific image attributes and image content. Automating the process provides a way for animation designers to save valuable time, since no human interaction is needed. In at least one embodiment, the automated animation techniques are applied to light-field images, enabling a large number of parameters to be changed automatically and dynamically, to control the presentation of an image.

In at least one embodiment, an automatic animation authoring process generates customized animation for a image, such as a still light-field image, by automatically controlling and/or changing any number of animation parameters, such as tempo, rate of change, and virtual camera parameters, based on analysis of the image. By taking into account the content of the image, the automated animation process described herein provides improved results as compared with systems that simply perform basic panning and/or zooming without regard to image content.

Examples of the type of information that can be used in generating customized animation include, without limitation:
A. Image coloration analysis, such as analysis of hue, saturation, intensity, and/or distribution;
B. Image feature identification, such as detection of faces, blue sky, grass, flowers, and/or the like;
C. Facial identification, optionally including detection of mood and/or expression, such as anger, happiness, sadness, and/or the like;
D. Gaze direction analysis; and
E. Object depth analysis, as may be reconstructed from the light-field, for use in controlling depth range, aperture, and focus points.

In at least one embodiment, an emotion index is derived from items such as (A), (B), and (C); this can be used, for example, to control speed (tempo) of the animation.

In at least one embodiment, image focal points are automatically derived, for example using information from items (B) (C) and (E). Spatial analysis of (A) can also be applied at potential focus points to further differentiate and prioritize potential focal points. If available, (D) can also be used to prioritize, select, and/or configure the animation, for example to determine the direction of transition of the view.

In at least one embodiment, an emotion index is determined from the detected scene content; this emotion index may then be used to determine a speed, tempo, and/or other parameters for the animation. By determining the emotion index, the automated process may generate an animation that is better suited for the particular image being displayed. Additional features of the image (such as emotion and determined direction of gaze of image subjects) can be used to prioritize, select, and/or configure animation parameters for the animation.

### BRIEF DESCRIPTION OF THE DRAWINGS

The accompanying drawings illustrate several embodiments. Together with the description, they serve to explain the principles of the embodiments. One skilled in the art will recognize that the particular embodiments illustrated in the drawings are merely exemplary, and are not intended to limit scope.

FIG. 1 depicts a portion of a light-field image.

FIG. 2 depicts an example of an architecture for implementing the methods of the present disclosure in a light-field capture device, according to one embodiment.

FIG. 3 depicts an example of an architecture for implementing the methods of the present disclosure in a post-processing system communicatively coupled to a light-field capture device, according to one embodiment.

FIG. 4 depicts an example of an architecture for a light-field camera for implementing the methods of the present disclosure according to one embodiment.

FIG. 5 is a flow diagram depicting the processes that may be used to generate an animation, according to one embodiment.

FIG. 6A is a series of images depicting the use of various characteristics of a feature within an image to abstract the features from others within the image.

FIG. 6B is a series of images depicting the identification of a feature of an image.

FIG. 7 is a flow diagram depicting a method of generating an animation, according to one embodiment.

FIG. 8 is a screenshot diagram depicting how an animation may be automatically generated, according to one embodiment.

FIG. 9 is a screenshot diagram depicting how an animation may be automatically generated, according to another embodiment.

FIG. 10 is a screenshot diagram depicting how an animation may be automatically generated, according to yet another embodiment.

FIG. 11 is a screenshot diagram depicting how an animation may be automatically generated, according to still another embodiment.

### DEFINITIONS

For purposes of the description provided herein, the following definitions are used:
Animation: a dynamic presentation of an image wherein, during the image display, some visible parameter of the image is changed over time
Animation parameter: a characteristic of an animation, such as tempo, smoothness of motion, virtual camera parameters, etc.
Attribute: a characteristic of an object or data structure
Automatic: a step that is performed by a computing device without requiring user input to initiate the step or to control the manner in which the step is performed.
Background: a portion of an image in which one or more objects are further from the camera, relative to one or more other portions of the image.
Coloration: the manner in which color is used in an image or region of interest.
Computer-recognizable human face: a feature that can be classified in an object class corresponding to human faces by a computer without human intervention.
Computer-recognizable feature: a feature that can be classified in an object class by a computer without human intervention.
Depth: a representation of distance between an object and/or corresponding image sample and a microlens array of a camera.
Depth map: a two-dimensional map corresponding to a light-field image, indicating a depth for each of multiple pixel samples within the light-field image.
Disk: a region in a light-field image that is illuminated by light passing through a single microlens; may be circular or any other suitable shape.
Emotion index: an indication of emotional content that would likely be conveyed by an image or region of interest to most viewers, including one or more numerical scores, category designations, and/or other indicators of emotion.
Extended depth of field (EDOF) image: an image that has been processed to have objects in focus along a greater depth range.
Feature: a subset of an image that can be differentiated by a computer from other portions of the image.
Foreground: a portion of an image in which one or more objects are closer to the camera, relative to one or more other portions of the image.
Gaze direction: the direction in which one or more individuals in an image are believed to be looking.
Image: a two-dimensional array of pixel values, or pixels, each specifying a color.
Image attribute: a characteristic of an image such as color, luminance, exposure, contrast, presence of an object appearing in the image, depth of an object in the image, and the like
Light-field data: data indicative of the intensity and origin of light received within a system such as a light-field camera.
Light-field image: an image that contains a representation of light-field data captured at the sensor.
Microlens: a small lens, typically one in an array of similar microlenses.
Object class: a category of objects.
Region of interest: a subset of an image that has been designated for further analysis.
Virtual camera: a viewpoint from which an image is rendered for purposes of generating an animation; may be static or dynamic.
Virtual camera attribute: a characteristic of a virtual camera indicative of how objects are viewed through the virtual camera, such as aperture, depth-of-field, focus depth, field of view, f-stop, etc.
Virtual camera parameter: a characteristic of a virtual camera, such as motion characteristics or virtual camera attributes.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

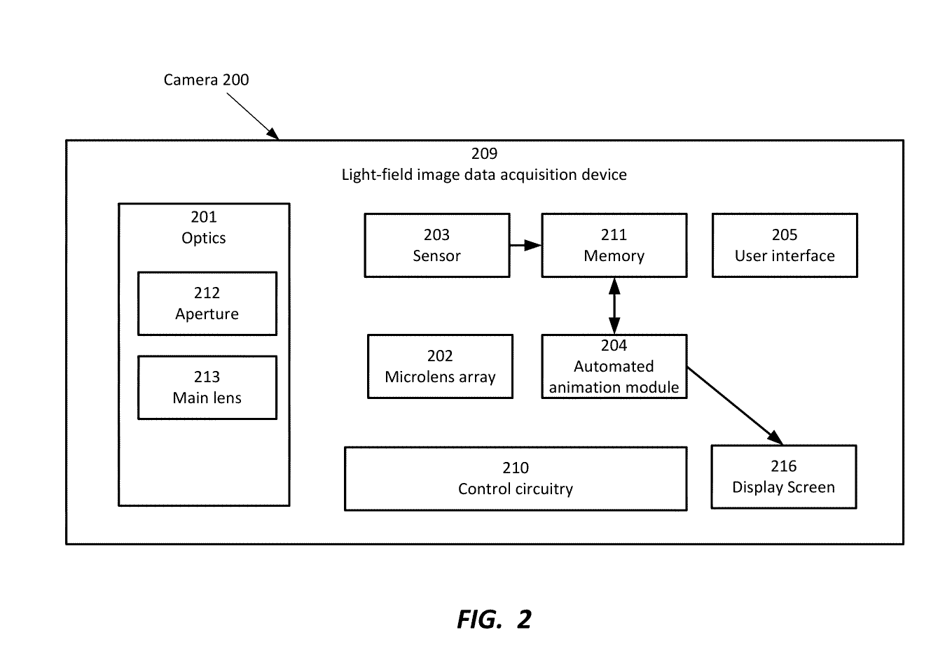

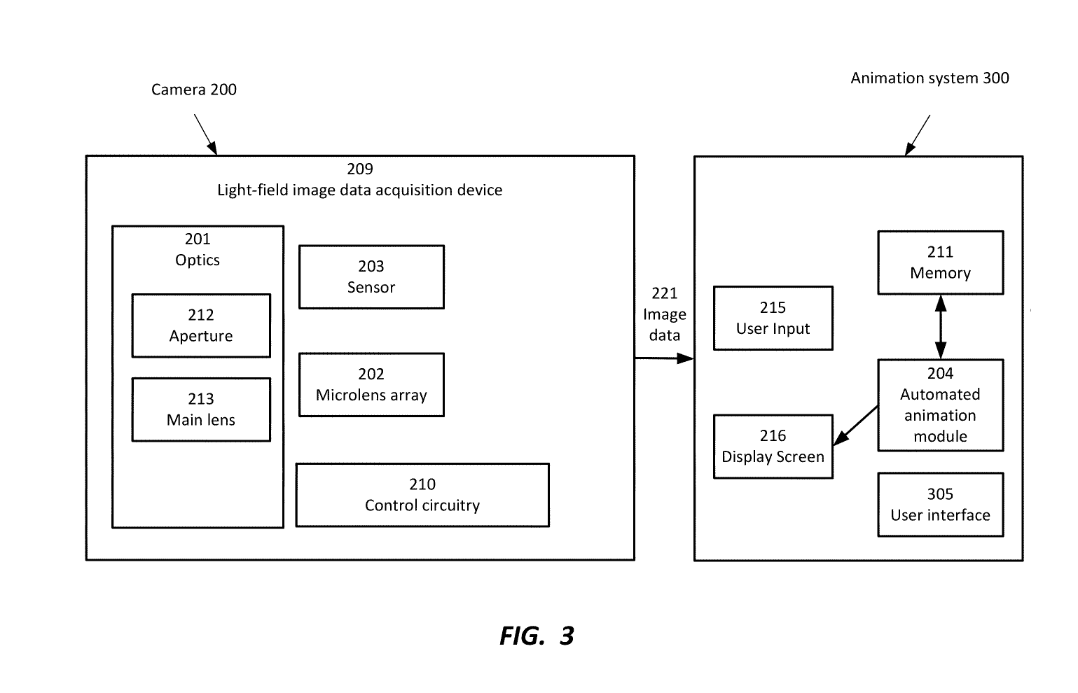

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. Referring now to FIG. 2, there is shown a block diagram depicting an architecture for implementing the method of the present disclosure in a light-field capture device such as a camera 200. Referring now also to FIG. 3, there is shown a block diagram depicting an architecture for implementing the method of the present disclosure in an animation system 300 communicatively coupled to a light-field capture device such as a camera 200, according to one embodiment. One skilled in the art will recognize that the particular configurations shown in FIGS. 2 and 3 are merely exemplary, and that other architectures are possible for camera 200. One skilled in the art will further recognize that several of the components shown in the configurations of FIGS. 2 and 3 are optional, and may be omitted or reconfigured.

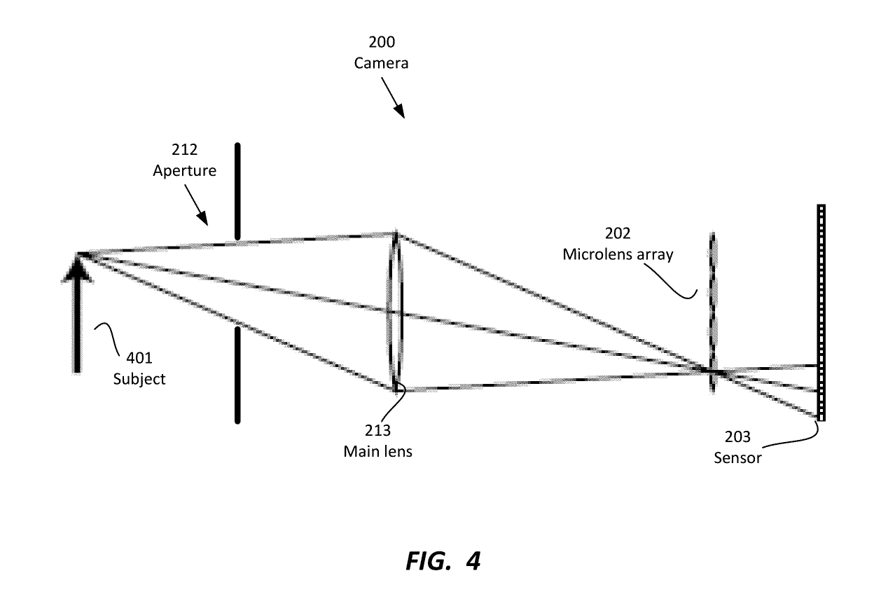

In at least one embodiment, camera 200 may be a light-field camera that includes light-field image data acquisition device 209 having optics 201, image sensor 203 (including a plurality of individual sensors for capturing pixels), and microlens array 202. Optics 201 may include, for example, aperture 212 for allowing a selectable amount of light into camera 200, and main lens 213 for focusing light toward microlens array 202. In at least one embodiment, microlens array 202 may be disposed and/or incorporated in the optical path of camera 200 (between main lens 213 and sensor 203) so as to facilitate acquisition, capture, sampling of, recording, and/or obtaining light-field image data via sensor 203. Referring now also to FIG. 4, there is shown an example of an architecture for a light-field camera 200 for implementing the method of the present disclosure according to one embodiment. The Figure is not shown to scale. FIG. 4 shows, in conceptual form, the relationship between aperture 212, main lens 213, microlens array 202, and sensor 203, as such components interact to capture light-field data for subject 401.

In at least one embodiment, light-field camera 200 may also include a user interface 205 for allowing a user to provide input for controlling the operation of camera 200 for capturing, acquiring, storing, and/or processing image data.

Similarly, in at least one embodiment, animation system 300 may include a user interface 305 that allows the user to provide input to control and/or activate automated animation, as set forth in this disclosure. The user interface 305 may facilitate the receipt of user input from the user to establish one or more parameters of the automated animation process.

In at least one embodiment, light-field camera 200 may also include control circuitry 210 for facilitating acquisition, sampling, recording, and/or obtaining light-field image data. For example, control circuitry 210 may manage and/or control (automatically or in response to user input) the acquisition timing, rate of acquisition, sampling, capturing, recording, and/or obtaining of light-field image data.

In at least one embodiment, camera 200 may include memory 211 for storing image data, such as output by image sensor 203. Such memory 211 can include external and/or internal memory. In at least one embodiment, memory 211 can be provided at a separate device and/or location from camera 200, such as the animation system 300.

In at least one embodiment, captured image data is provided to automated animation module 204. Such module 204 may be disposed in or integrated into light-field image data acquisition device 209, as shown in FIG. 2, or it may be in a separate component external to light-field image data acquisition device 209, such as the animation system 300 of FIG. 3. Such separate component may be local or remote with respect to light-field image data acquisition device 209. Any suitable wired or wireless protocol can be used for transmitting image data 221 to module 204; for example camera 200 can transmit image data 221 and/or other data via the Internet, a cellular data network, a WiFi network, a Bluetooth communication protocol, and/or any other suitable means.

The animation system 300 may include any of a wide variety of computing devices, including but not limited to computers, smartphones, tablets, cameras, and/or any other device that processes digital information. The animation system 300 may include additional features such as a user input 215 and/or a display screen 216. If desired, light-field image data may be displayed for the user on the display screen 216, which may be part of camera 200 or, or may be part of animation system 300, or may be a separate component.

### Projection of Light-Field Images

Light-field images often include a plurality of projections (which may be circular or of other shapes) of aperture 212 of camera 200, each projection taken from a different vantage point on the camera's focal plane. The light-field image may be captured on sensor 203. The interposition of microlens array 202 between main lens 213 and sensor 203 causes images of aperture 212 to be formed on sensor 203, each microlens in microlens array 202 projecting a small image of main-lens aperture 212 onto sensor 203. These aperture-shaped projections are referred to herein as disks, although they need not be circular in shape. The term “disk” is not intended to be limited to a circular region, but can refer to a region of any shape.

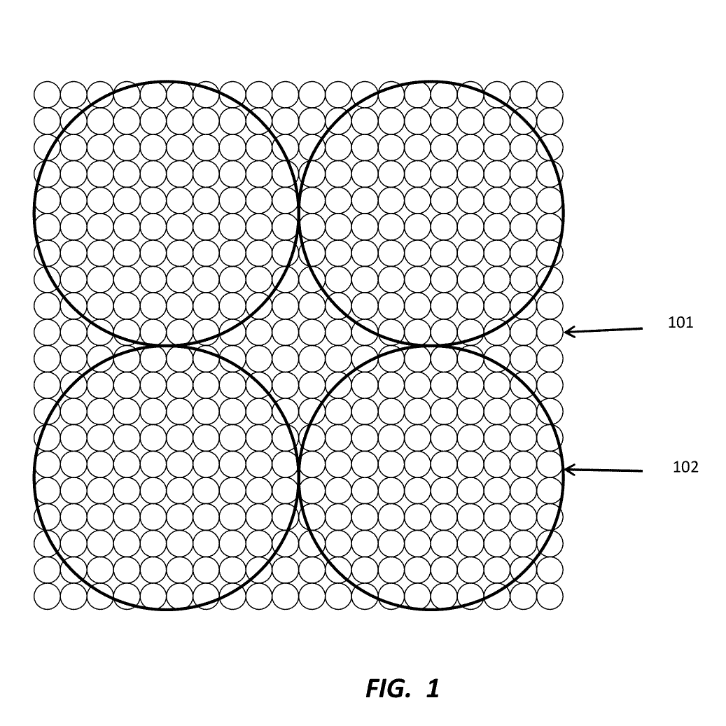

Light-field images include four dimensions of information describing light rays impinging on the focal plane of camera 200 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x,y,u,v) resolution of (400,300,10,10). Referring now to FIG. 1, there is shown an example of a 2-disk by 2-disk portion of such a light-field image, including depictions of disks 102 and individual pixels 101; for illustrative purposes, each disk 102 is ten pixels 101 across.

In at least one embodiment, the 4-D light-field representation may be reduced to a 2-D image through a process of projection and reconstruction.

### Automatic Animation Generation

The system and method of the present disclosure may automatically generate an animation that can be used to enhance the display of an image. The system and method may be applied to a variety of image types, including but not limited to conventional two-dimensional images, light-field images, stereoscopic images, and multi-scopic images. Images with depth-based information, such as light-field images, stereoscopic images, and multi-scopic images, may facilitate the use of feature recognition and/or depth-based animation techniques; however, many of the techniques and methods presented below are also applicable to conventional two-dimensional images.

In at least one embodiment, color analysis, image content recognition, and/or facial expression recognition are used to determine an emotion index. Image content recognition, facial expression recognition, gaze direction, and/or depth/3D analysis are used to control virtual camera parameters. The emotion index (including factors such as speed/tempo) and the virtual camera parameters are used to generate an animation, as described in more detail below.

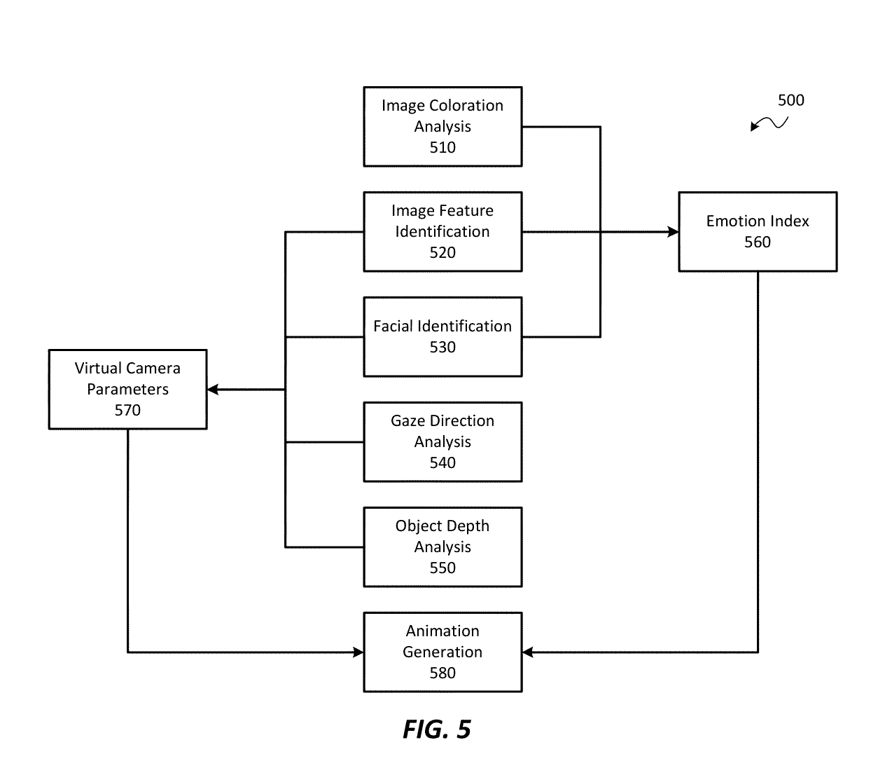

Referring to FIG. 5, a flow diagram 500 depicts the processes that may be used to generate an animation, according to one embodiment. As shown, image attributes may be gathered through the use of processes such as, but not limited to, image coloration analysis 510, image feature identification 520, facial identification 530, gaze direction analysis 540, and/or object depth analysis 550.

One or more attributes of the image discovered through the use of image coloration analysis 510, image feature identification 520, and/or facial identification 530 may be used to generate an emotion index 560. The emotion index may include one or more numerical scores, category designations, and/or other indicators of the emotion that would likely be conveyed by the image to most viewers. Thus, by way of example, the emotion index may indicate that the image is likely to convey emotions such as love, joy, surprise, anger, sadness, and/or fear.

Additionally or alternatively, one or more attributes of the image discovered through the use of image feature identification 520, facial identification 530, gaze direction analysis 540, and/or object depth analysis 550 may be used to generate one or more virtual camera parameters 570. The virtual camera parameters 570 will hereafter be referred to as multiple virtual camera parameters even though there may be one or more virtual camera parameter(s) that is/are established through the use of image attributes.

The virtual camera may be the viewpoint from which the image is rendered for purposes of generating the animation. The virtual camera may move relative to the image (for example, to zoom into the image, zoom out of the image, rotate the image, and/or pan across a portion of the image). Alternatively, the virtual camera may remain stationary, but may have one or more camera attributes that change over time. Such camera attributes may include, but are not limited to, zoom/field-of-view settings, f-stop settings, aperture settings, lens filter settings, depth-of-field settings, and/or the like.

The emotion index 560 and/or the virtual camera parameters 570 may be used to establish one or more animation parameters. The animation parameters may include virtual camera parameters and/or other parameters such as tempo, which may determine whether the overall speed of the animation is fast or slow. The one or more animation parameters may, in turn, be used for animation generation 580. Image coloration analysis 510, image feature identification 520, facial identification 530, gaze direction analysis 540, and object depth analysis 550 will be described in greater detail below.

### Image Coloration Analysis

The image coloration analysis 510 may entail analyzing the colors used in the entire image. Alternatively, color analysis may be limited to one or more specific regions of interest (ROIs).

Color may have different meanings in different cultural contexts. For example, a color that often represents peace or joy in one culture may represent anger or anxiety in another. Accordingly, in at least one embodiment, the system employs localization to determine which cultural connotations to use for the detected color. For example, the GPS coordinates of the location at which the image is captured, at which the animation is generated, and/or at which the animation is to be viewed may be used to properly interpret the emotions conveyed by the colors in the image or ROI.

Color analysis can include analysis of, for example, brightness, hue, chrominance, and/or the like. Global statistics of the image as a whole or of the ROI may be generated and mapped to an emotion index. In at least one embodiment, if certain features are identified within the image, such features can be weighted higher than others when determining overall color. For example, features determined to be at or near the center of image, or in the foreground of the image (as opposed to at the periphery and/or in the background), or in focus, may be weighted more heavily than other features.

This process may entail deconstruction of the image or ROI into one or more regions and/or features of distinct color. The regions and/or features may then be re-aggregated to determine the overall emotion of the image or ROI.

In at least one embodiment, analysis is performed by converting the non-perceptual-based RGB values to standard perceptual-based color space, such as YCbCr, CIELab or HSV. However, any suitable color space can be used.

For example, HSV is a cylindrical geometry, wherein the central vertical axis includes the neutral or gray colors, ranging in brightness from black at value 0 (at the bottom), to white at value 1 (at the top). The angular orientation around the central vertical axis corresponds to hue, and the distance from the axis corresponds to saturation.

According to one embodiment, the RGB value of each pixel in the image may be converted into an HSV value. An emotional image classification model based on the statistics of brightness, hue, and saturation can then be used to determine parameters of the generated animation, such as speed and/or tempo. These color attributes can be further converted into more meaningful emotion scales, such as activity, weight and heat. Such emotion scales may be used to construct the emotion index 560. See, for example, Martin Solli, Color Emotions in Large Scale Content Based Image Indexing, PhD thesis, 2011.

The emotion scales described above can be translated and correlated with any of a variety of parameters of the animation. In some examples, the emotion scales may be used to determine parameters such as the animation's speed and/or tempo. For example, warm and light colors may cause the resulting animation to have a fast tempo, while cool and heavy colors may cause the resulting animation to have a peaceful and/or slow tempo.

In at least one embodiment, image content itself is considered on a basic level in determining characteristics of the animation. For example, fast animation may be avoided for a dimly lit scene, simply because the viewer cannot keep up with low-contrast scenes. Similarly, a scene with many small, distinct objects or color regions may result in a slower animation to give the viewer the time needed to perceive the detail, while an image with fewer details may result in a more rapid animation.

### Image Feature Identification

In at least one embodiment, the system performs image feature identification 520 by identifying one or more features within the image, and then obtains specific information about each of the features. For example, the system may determine the saliency of the feature based on any available information, such as the amount of color variation in the feature, whether the feature has an interesting texture on it, whether text is present on the feature, and/or the like. Such information can help in determining the importance level to be assigned to the feature. In some embodiments, each feature of an image may be assigned a weight that can be used to indicate relative importance of features in order to select one or more of the animation parameters.

In at least one embodiment, feature recognition can be performed based on low-level attributes of the image or region of interest, such as a color histogram of the image, a color composition of the image, and textures present within the image. See, for example, Yi Li, Object and concept recognition for content-based image retrieval, PhD thesis, 2005.

In at least one embodiment, various types of features can be recognized automatically, which may include, but are not limited to:
Human faces;
Human bodies;
Animals; and
Backgrounds, such as blue sky, jungles, water, or city buildings.

In at least one embodiment, the image can be classified into one or more categories, which may include, but are not limited to:
People;
Natural scenes;
Animals; and
City life.

This classification may be made, for example, based on identification of one or more features of the image that pertain to the image type. For example, an image in which one or more office buildings are identified may be classified as depicting “city life.” A particular type of animation or style may be applied to each image category. The animation type or style for a category may include animation parameters such as the speed or tempo of the animation, one or more virtual camera parameters, and/or the like.

Examples of attributes of a region of interest of an image that can be used in object class recognition to identify features may include, but are not limited to:
Color;
Texture;
Structure; and
Position within the image.

In some cases, the shape of a region, such as the elliptical shape of a vehicle wheel or the rectangular shape of a sailboat, can also be used for feature identification. In various embodiments, recognition of different features may be used to classify the recognized feature in an object class. The granularity of the object classes may be determined based on how finely the animation parameters are to be tuned. More granular classification may require more processing time, but may provide more accurate feature identification, and thus, a more refined animation of the image.

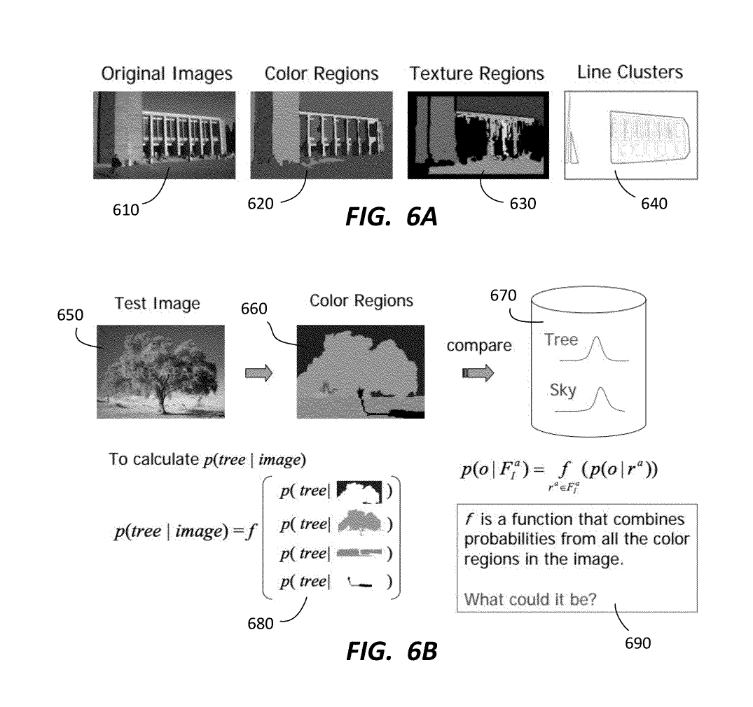

Referring to FIG. 6A, a series of images 610, 620, 630, 640 that depict the use of various characteristics of a feature within an image to abstract the features from other features within the image. As shown by way of example, color regions, texture regions, and/or line clusters may be used to delineate a region of the image containing a feature, such as the façade of a building, as shown in the image 620, the image 630, and the image 640, respectively. The image 610 may be the original image or a region of interest therein.

The region attributes of each abstracted region may then be labeled as objects for object model learning. In at least one embodiment, an assumption is made that the feature distribution of each object within a region is a Gaussian distribution. Each image is a set of regions; each region can be modeled as a mixture of multivariate Gaussian distributions. A semi-supervised EM-like algorithm may be used to generate the multivariate Gaussian distribution model using all the region features from all images that contain the object. See, for example, Yi Li, etc., Object Class Recognition using Images of Abstract Regions; and Yi Li et al, Object Class Recognition Using Images of Abstract Regions, in Proceedings of the 17th International Conference on Pattern Recognition, 2004.

Referring to FIG. 6B, a series of images 650, 660, 670, 680, 690 depict the identification of a feature of an image. Once the region containing the feature has been abstracted (for example, as described in connection with FIG. 6A), the feature shown in that region may be identified. This may entail placing the feature in an object class, as indicated previously. This may be done, for example, by calculating the probability p(object|image) that a given region depicts a particular object class using all the feature regions in the image.

FIG. 6B depicts an example of such calculation to recognize a tree in an image. The test image 650 may be the original image. In the image 660, the test image 650 may be abstracted into regions through the use of color analysis. The regions identified may be the tree, sky, ground, and shadow, as set forth in the image 680. The image 690 indicates how the calculation of probability may be performed to identify the feature present in a region.

### Facial Identification

In various embodiments, the system may perform facial identification 530 through the use of any of a variety of facial detection methods known in industry and/or in academic usage. Any existing method can be used to identify facial locations in the image, for example by generating regions of interest (ROIs—denoted by bounding boxes) where faces are detected in the image. These regions of interest may represent top-level face image features that are then fed into further facial and emotional recognition portions of the algorithm.

Additionally, during this stage, in at least one embodiment, the system uses facial detection methods that support multi-view perspectives of the face that can be used for providing orientation information. Such orientation information may be used to ascertain the orientation of the face.

See, for example: P. Viola and M. Jones, Rapid Object Detection using a Boosted Cascade of Simple Features, Accepted Conference on Computer Vision and Pattern Recognition, 2001; and M. Jones and P. Viola, Fast Multi-view Face Detection, Mitsubishi Electric Research Laboratories, 2003.

### Facial Expression Identification

The mere identification of a feature of an image as a face can raise the priority of the feature, so that the characteristics of the face are considered more important than those of other objects in the scene for purposes of identifying emotional content. Thus, any attributes of the identified face may factor relatively more prominently in the selection of animation attributes.

In at least one embodiment, when a face is detected and of sufficient size, the facial expression is automatically analyzed to classify its expression or weight of expressions. If an expression is detected to a sufficient confidence, it may be used in determining the emotion index 560. Thus, facial expressions may be used in determining the animation parameters of the animation. Such animation parameters may include, but are not limited to, tempo, smooth versus abrupt motion, and the like.

### Emotion Identification

In at least one embodiment, once a face has been identified within the image, the system analyzes the face for specific emotions. Example emotions include, but are not limited to:
Neutral;
Ecstasy;
Grief (Sadness);
Anger;
Love;
Happiness (Joy);
Surprise; and
Fear

Various approaches may be used to identify the emotion(s) present in a face. Two exemplary approaches for scoring a feature of an image for emotion are an image-based approach and a mesh-based approach.

In an image-based approach, machine learning may be used for categorization via Principal Component Analysis. See, for example, M. Turk and A. Pentland, Eigenfaces for Recognition, Journal of Cognitive Neuroscience, vol. 3, no. 1, 1991. First, training data may be provided. A large set of faces may be categorized manually, with each face being matched to an emotion. A representation for the clustering of emotions in this image space may then be generated to categorize new images that are not part of the training set. Principal Component Analysis (PCA) is one technique that can be used for determining image components that are highly correlated to the respective emotional categories.

This clustering and categorization method can be employed either on the entire face, or on sub-regions of the face (for example, upper face or lower face). Other techniques can be used, such as: normalization of skin tones by operating in different color spaces such as HSL, where skin tones are more tightly coupled compared to RGB; detecting and masking out hair; and/or the like.

In a mesh-based approach, a coarse mesh model of a representative face may be fitted to the face region. The vertices of the mesh may be set to align with a coarse set of features that are easier to detect, such as eyes, lips, jaw, and/or the like. The mesh, fitted to the target face, can then be used to topologically match key components of the emotional expression. For example, the mesh may be used to determine that a face has a smile and open eyes. The face may be classified as evincing happiness. Conversely, the mesh may be used to determine that a face has pursed lips and wrinkled eyebrows. The face may be classified as evincing anger. See V. Bettadapura, Face Expression Recognition and Analysis: The State of the Art, Tech Report, 1-27, 2012.

When multiple facial regions exist in an image, several aspects can be considered for combining the results:
Size: large facial regions can be used to prioritize prominent subjects. Additionally, small clusters of separate faces can be aggregated to a group priority.
Gaze direction: Since gaze direction can be used to inform the animation movement to be aligned and synergetic (as described below), if the gaze is in the same direction as that of another face, this direction may be weighted/prioritized higher in selecting the final animation direction.
Emotional agreement or dissonance: If the emotions of multiple faces within an image are significantly different and/or opposite (for example, a happy face and a sad face within the same image), this information may be used to establish animation parameters that transition from one emotion to the other. For example, virtual camera parameters such as image composition and/or shallow depth of field (large aperture with blur) can be used to initially hide one or more faces with an emotion that contrasts with that of one or more other faces that are initially visible. The virtual camera parameters may then be transitioned to reveal the previously hidden face(s).

### Gaze Direction Analysis

In at least one embodiment, when a face is detected, the system performs gaze direction analysis 540. This may commence with determination of the locations of the eyes of the subject. If possible (for example if the eyes are not occluded by sunglasses), the locations of the pupils are used to determine gaze direction. In at least one embodiment, this direction is used in establishing the animation parameters, for example to help prioritize the direction of motion for the animation.

In at least one embodiment, gaze direction is detected from the eyes by first detecting the eyes within the facial region. The relative locations of the dark regions of the eyes (iris & pupil) to the whites of the eyes may be ascertained to detect strong shifts in gaze.

In at least one embodiment, even when eyes and/or pupils are not fully resolvable, the direction of the face can be used to determine the probable gaze direction. 3D depth information (discussed below) can be used to locate the direction of the gaze, for example via detection of the nose and relative location to other facial features, such as the eyes and/or chin, and their warping/projection from 3D space to image space.

The gaze direction then can be used to establish animation parameters such that the resulting animation is aligned with and/or synergetic with the gaze direction. The animation may, for example, move along the gaze direction to focus on the subject or direction in which the subject is looking.

### Object Depth Analysis

In at least one embodiment, the techniques described herein are applied to light-field images. Such light-field images may provide enough information (as well as images from different perspectives) to reconstruct scene depth. This may be done by generating a depth map, which is an image, normally grayscale, which corresponds to the light-field image to indicate the depth of objects, relative to the camera, within the light-field image. The depth map may be used for detecting significant spatial features.

In at least one embodiment, depth clustering is used. Regions that have large consistencies of depth may be identified, indicating the likelihood that the image contains a large connected object in a particular location. Thus, features that exist at multiple depths within the image may be delineated and/or identified.

Depth information may also help to establish animation parameters such as virtual camera parameters to properly visualize a feature of the image within the animation. Such virtual camera parameters may include, but are not limited to, focus and aperture range. The depth information may also allow the virtual camera provide an accurate view of the object as the camera pivots.

Additionally, in at least one embodiment, depth information may be used to assist in gaze direction analysis 540, as described above, by providing information and silhouette of a subject's head. The depth information may additionally or alternatively be used to facilitate image coloration analysis 510, image feature identification 520, and/or facial identification 530.

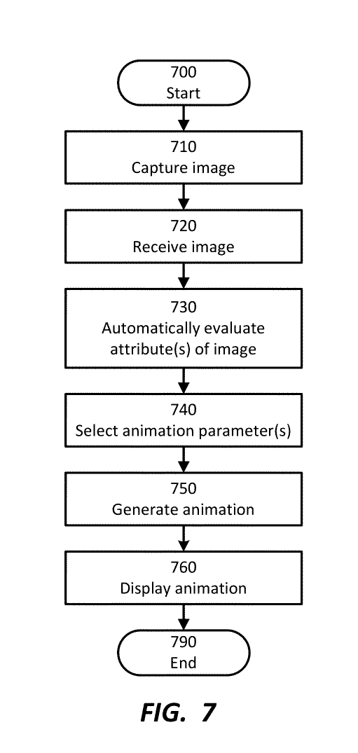

FIG. 7 is a flow diagram depicting a method of generating an animation, according to one embodiment. The following description refers to processing a light-field image, generated through the use of a camera such as the camera 200 of FIG. 2. However, the method may be performed with any type of image, as described above.

The method may be performed, for example, by automated animation module 204 of the camera 200 of FIG. 2 or by automated animation module 204 of the animation system 300 of FIG. 3, which is independent of the camera 200. In some embodiments, a computing device may carry out the method; such a computing device may include one or more of desktop computers, laptop computers, smartphones, tablets, cameras, and/or other devices that process digital information.

The method may start 700 with a step 710 in which the image (for example, a light-field image) is captured, for example, by the sensor 203 of the camera 200. In a step 720, the image may be received in a computing device, which may be the camera 200 as in FIG. 2. Alternatively, the computing device may be separate from the camera 200 as in the animation system 300 of FIG. 3, and may be any type of computing device, including but not limited to desktop computers, laptop computers, smartphones, tablets, and the like.

In a step 730, one or more attributes of the image may automatically be evaluated. Such evaluation may include image coloration analysis 510, image feature identification 520, facial identification 530, gaze direction analysis 540, and/or object depth analysis 550, as described above. Additionally or alternatively, any other attributes of the image may be evaluated, such as camera settings, image metadata, and/or the like.

In a step 740, the one or more attributes of the image that were evaluated in the step 730 may be used to select one or more animation parameters. Such animation parameters may include, but are not limited to, virtual camera translation and/or rotation, virtual camera attributes, animation tempo, and the like. Selecting animation parameters may include defining a change over time of any animation parameter or parameters. For example, an animation parameter may specify a virtual camera attribute in the form of a depth-of-field for the camera. The animation may further specify the manner in which the depth-of-field is to change over the course of the animation.

In a step 750, the animation may be generated. This may be done using the one or more animation parameters selected in the step 740. In some embodiments, the step 750 may involve the modification of a default set of animation parameters. Any animation parameters selected in the step 740 may be used to replace their counterparts in the default set of animation parameters. Any of the animation parameters for which parameters were not selected in the step 740 may remain at their default settings. Thus, the step 740 need not necessarily define all parameters needed to generate the animation, but may rather specify only the animation parameters that are to be changed from their default values.

The determination of emotion for the entire image, and/or for individual elements of the image, may be used to determine what type of animation to apply and/or how to apply it. In at least one embodiment, a lookup table can be provided to map emotions to speed of animation, complexity of animation, path of movement, and/or other animation parameters. Mappings can be specified by enumeration among all possible emotions; alternatively, a spectrum along any number of axes can be established, which translate into different parameters of the animation (speed, complexity, and/or the like). In at least one embodiment, a user can configure the automatically generated animations as desired.

In at least one embodiment, projections of light-field images are used to generate individual frames of the animations, with time-varying parameters as dictated by the analysis. The use of light-field images in this manner may provide a greater variety of animation styles and techniques, which may include, but are not limited to:
Changing the focus of the image or a portion thereof;
Changing the hue or saturation of the image or a portion thereof;
Changing the perspective (viewpoint) of the image or a portion thereof; and
Changing the aperture and/or illumination of the image or a portion thereof.

In a step 760, the animation generated in the step 750 may be displayed for the user. This may be done, for example, on the display screen 216 of the animation system 300. The animation may be generated “on-the-fly,” or may be saved to memory in the course of the step 740 to ensure that it can be displayed for the user without hiccups or delays. The method may then end 790.

The method of FIG. 7 is only one of many possible methods that may be used to automatically generate an animation of an image. According to various alternatives, various steps of FIG. 7 may be carried out in a different order, omitted, and/or replaced by other steps. For example, other image processing steps such as color space conversion, blurring, Automatic White Balance (AWB) algorithms and/or any other image processing steps set forth above may be incorporated into the method of FIG. 6, at any stage of the method, and may be carried out with respect to the image prior to, during, and/or after generation of the animation.

### Examples

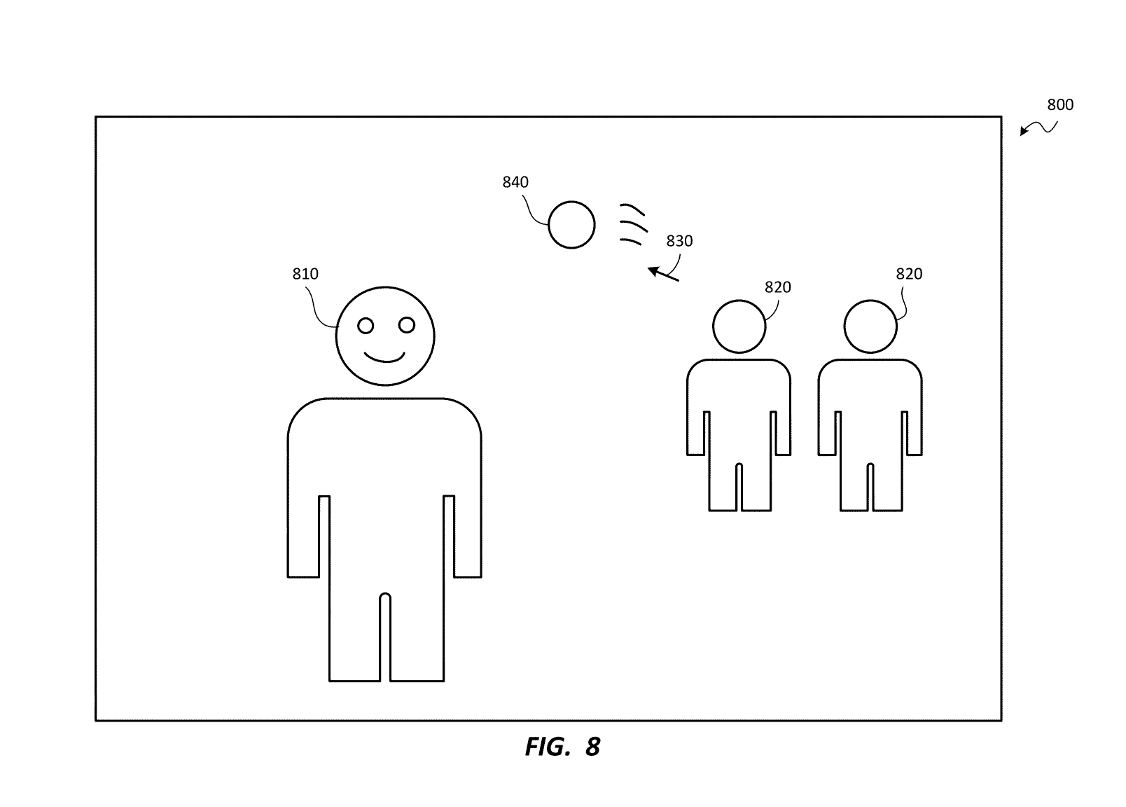

Referring to FIG. 8, a screenshot diagram 800 depicts how an animation may be automatically generated, according to one embodiment. In this scene, a primary subject 810 is unaware of a water balloon 840 approaching from secondary subjects 820. Primary subject 810 is detected by facial detection, and selected for priority since it is the largest face. Secondary subjects 820 are also detected from facial detection. The water balloon 840 is detected from the depth map for the image. The gaze 830 of secondary subjects 820 is detected in the direction of water balloon 840 and primary subject 810.

Based on this analysis of the scene, automated animation module 204 automatically generates an animation to present the scene dynamically on display screen 216. Since the primary subject 810 has a neutral gaze and happy expression, the animation starts with only the primary subject 810 in view, with composition and aperture depending on spatial separation available in the image. The animation then pulls back gradually to include the secondary subjects 820 and the water balloon 840. Since the gaze of the secondary subjects 820 is in the same direction as that of the primary subject 810, the transition keeps the primary subject 810 in view. The depth-of-field may remain broad enough to keep the primary subject 810 unblurred as the secondary subjects 820 come into view.

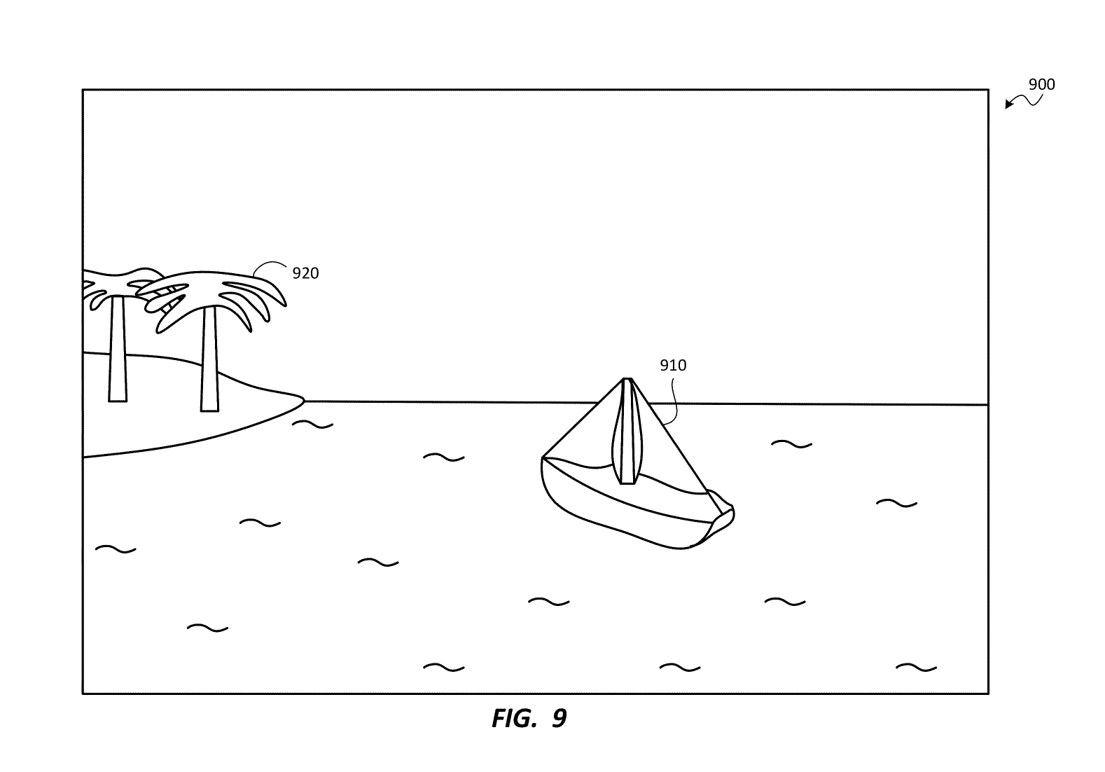

Referring to FIG. 9, a screenshot diagram 900 depicts how an animation may be automatically generated, according to another embodiment. The image of the screenshot diagram 900 includes a boat 910 in water, with an island and trees 920 off in the distance.

No faces are detected in the image. The boat 910 may be detected as an important feature of the image from the depth map and/or image color saliency. The depth of the boat 910 is sufficiently large and stands out across the relatively flat water surface (flat in both color and depth progression). The trees 920 on the island may be identified as important features of the image through image color analysis (object detection). The image analysis can be of significance, since the island is relatively flat in depth.

Again, based on this analysis of the scene, automated animation module 204 automatically generates an animation to present the scene dynamically on display screen 216. The resulting animation includes both features (the boat 910 and the trees 920). Since the boat 910 is separated in depth from the trees 920, a perspective shift animation is chosen, so as to accentuate the relative motion. Also, in order to have a further synergetic effect on the perspective shift, the animation begins zoomed-in and centered towards the trees 920 and the island, and the camera is animated to zoom out to include the boat 910 with a perspective shift that gives the boat a further appearance of moving into view.

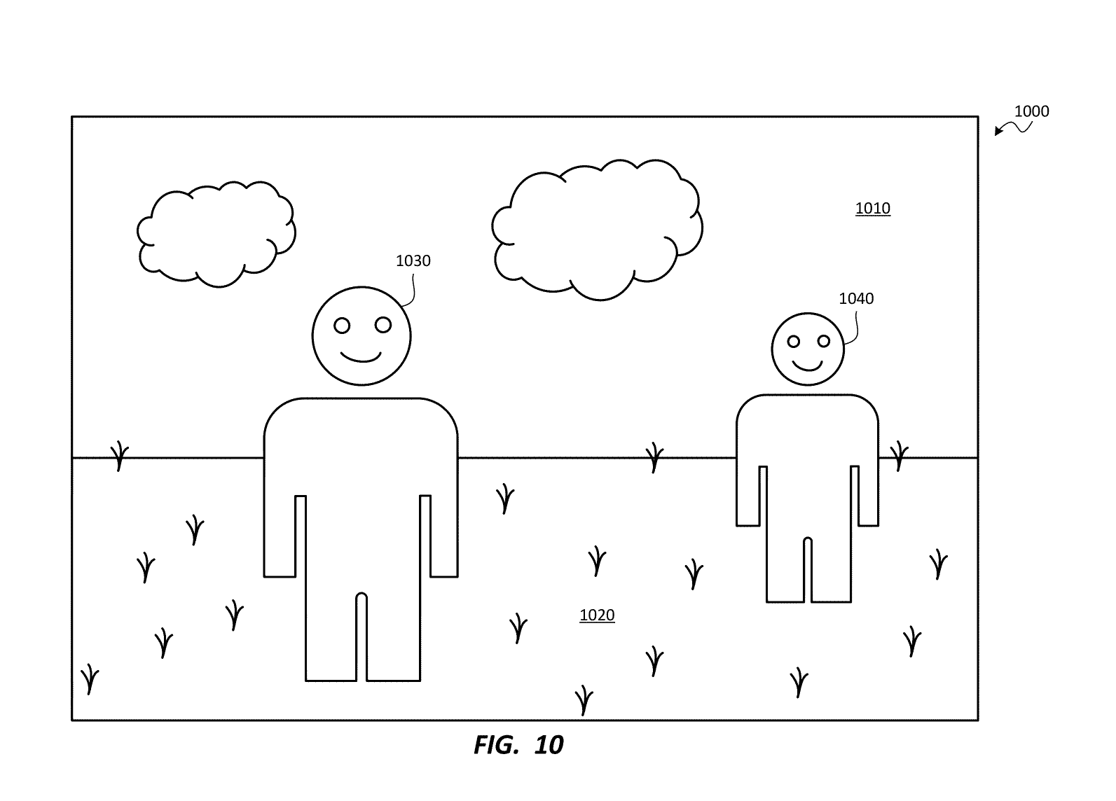

Referring to FIG. 10, a screenshot diagram 1000 depicts how an animation may be automatically generated, according to yet another embodiment. Various features of the image may be identified, including the sky 1010, grass 1020, a foreground human face 1030, and background human face 1040. Various factors, such as high image contrast, image content such as sky and grass, and smiling faces, contribute to an emotion index specifying happiness.

Again, based on this analysis of the scene, automated animation module 204 automatically generates an animation to present the scene dynamically on display screen 216. Since the image appears to depict a happy scene, a high-speed, energetic animation is generated. Image content, facial detection, and depth detection are used to determine that the animation should include a viewpoint and focus shift from the foreground human face 1030 to the background human face 1040. Image content can also be used to specify the camera aperture for the generated animation, and whether such aperture should change during the course of the animation.

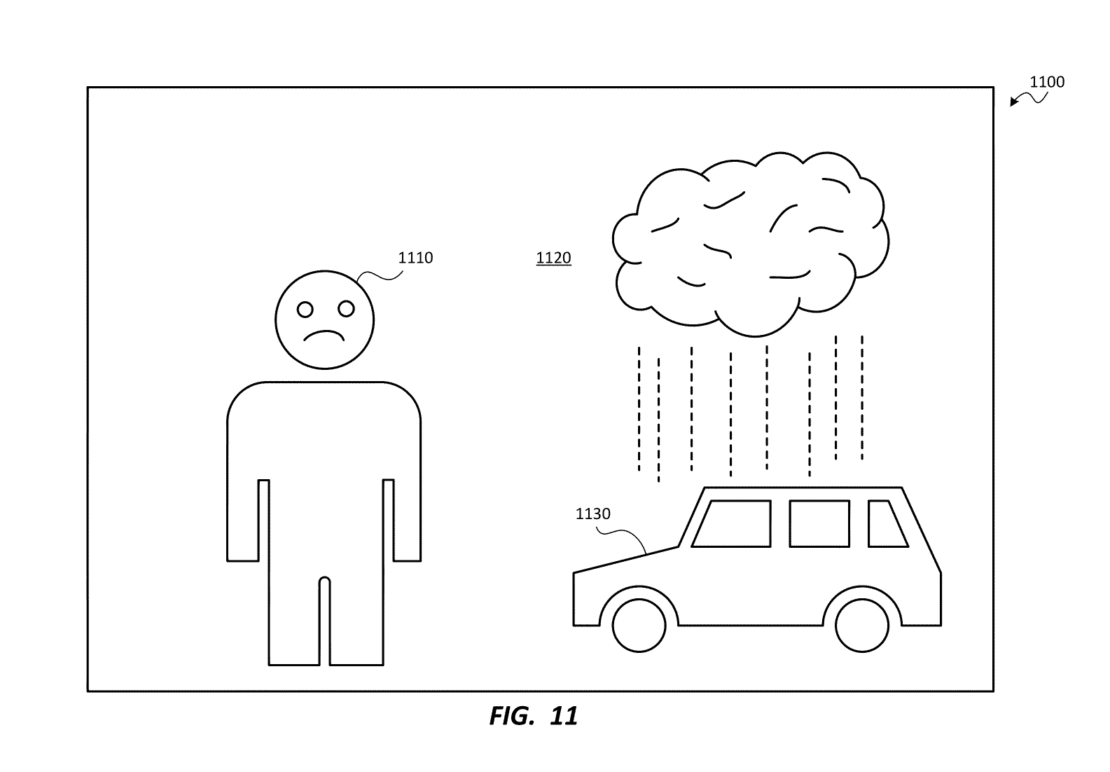

Referring to FIG. 11, a screenshot diagram 1100 depicts how an animation may be automatically generated, according to still another embodiment. Identified features of the image may include a sad human face 1110, cloudy sky with rain 1120, and broken car 1130. Various factors, such as low image contrast, low color saturation, the cloudy sky, and the sad expression of the sad human face 1110, may contribute to an indication of an emotion index specifying sadness.

Again, based on this analysis of the scene, automated animation module 204 automatically generates an animation to present the scene dynamically on display screen 216. Since the image appears to depict a sad scene, a slower, less energetic animation is generated. Image content, facial detection, and depth detection are used to specify that the animation should include a viewpoint and focus shift from the sad human face 1110 to the broken car 1130. As before, image content can also be used to specify the camera aperture for the generated animation, and whether such aperture should change during the course of the animation.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A method for animating presentation of an image, the method comprising:
in a data store, receiving the image;
in a processor, automatically evaluating one or more attributes of the image;
in the processor, based on the one or more attributes, automatically selecting a first animation parameter;
in the processor, generating an animation of the image such that the animation possesses the first animation parameter; and
on a display device, displaying the animation.

2. The method of claim 1, wherein the one or more attributes comprise a coloration of the image.

3. The method of claim 2, wherein automatically evaluating the one or more attributes comprises:
dividing the image into a plurality of regions; and
assessing coloration of each of the regions.

4. The method of claim 1, wherein the one or more attributes comprise presence of a computer-recognizable feature in the image.

5. The method of claim 4, wherein automatically evaluating the one or more attributes comprises:
dividing the image into a plurality of regions; and
using at least one of color, texture, shape, and position of a first region of the plurality of regions to identify the computer-recognizable feature in the first region.

6. The method of claim 1, wherein the one or more attributes comprise presence of a computer-recognizable human face in the image.

7. The method of claim 6, wherein automatically evaluating the one or more attributes comprises analyzing the computer-recognizable human face to assess an emotion expressed by the computer-recognizable human face.

8. The method of claim 1, wherein the one or more attributes comprise a gaze direction of a person appearing in the image.

9. The method of claim 8, wherein automatically evaluating the one or more attributes comprises:
identifying a pupil of the person; and
based on a location of the pupil relative to one or more other facial features of the person, assessing the gaze direction.

10. The method of claim 1, wherein the one or more attributes comprise a depth, relative to a camera used to capture the image, of an object appearing in the image.

11. The method of claim 10, wherein the image comprises a light-field image;
and wherein automatically evaluating the one or more attributes comprises using a depth map for the image, the depth map comprising the depth, to identify at least one significant spatial feature of the object.

12. The method of claim 1, wherein automatically selecting the first animation parameter comprises:
generating an emotion index indicative of an emotion conveyed by the image; and
using the emotion index to select the first animation parameter.

13. The method of claim 12, wherein the first animation parameter comprises a tempo of the animation.

14. The method of claim 1, wherein generating the animation comprises generating a view of the image through a virtual camera.

15. The method of claim 14, where the first animation parameter is selected from the group consisting of a change in an attribute of the virtual camera, and motion of the virtual camera.

16. The method of claim 1, wherein the image comprises a light-field image;
wherein generating the animation of the image comprises, for each frame of the image, generating a projection of the light-field image.

17. A non-transitory computer-readable medium for animating presentation of an image, comprising instructions stored thereon, that when executed by a processor, perform the steps of:
causing a data store to receive the image;
automatically evaluating one or more attributes of the image;
based on the one or more attributes, automatically selecting a first animation parameter;
generating an animation of the image such that the animation possesses the first animation parameter; and
causing a display device to display the animation.

18. The non-transitory computer-readable medium of claim 17, wherein the one or more attributes comprise a coloration of the image;
and wherein automatically evaluating the one or more attributes comprises:
dividing the image into a plurality of regions; and
assessing coloration of each of the regions.

19. The non-transitory computer-readable medium of claim 17, wherein the one or more attributes comprise presence of a computer-recognizable feature in the image;
and wherein automatically evaluating the one or more attributes comprises:
dividing the image into a plurality of regions; and
using at least one of color, texture, shape, and position of a first region of the plurality of regions to identify the computer-recognizable feature in the first region.

20. The non-transitory computer-readable medium of claim 17, wherein the one or more attributes comprise presence of a computer-recognizable human face in the image;
wherein automatically evaluating the one or more attributes comprises analyzing the computer-recognizable human face to assess an emotion expressed by the computer-recognizable human face.

21. The non-transitory computer-readable medium of claim 17, wherein the one or more attributes comprise a gaze direction of a person appearing in the image;
and wherein automatically evaluating the one or more attributes comprises:
identifying a pupil of the person; and
based on a location of the pupil relative to one or more other facial features of the person, assessing the gaze direction.

22. The non-transitory computer-readable medium of claim 17, wherein the one or more attributes comprise a depth, relative to a camera used to capture the image, of an object appearing in the image;
and wherein the image comprises a light-field image;
and wherein automatically evaluating the one or more attributes comprises using a depth map for the image, the depth map comprising the depth, to identify at least one significant spatial feature of the object.

23. The non-transitory computer-readable medium of claim 17, wherein automatically selecting the first animation parameter comprises:
generating an emotion index indicative of an emotion conveyed by the image; and
using the emotion index to select the first animation parameter;
and wherein the first animation parameter comprises a tempo of the animation.

24. The non-transitory computer-readable medium of claim 17, wherein generating the animation comprises generating a view of the image through a virtual camera;
where the first animation parameter is selected from the group consisting of a change in an attribute of the virtual camera, and motion of the virtual camera.

25. The non-transitory computer-readable medium of claim 17, wherein the image comprises a light-field image;
wherein generating the animation of the image comprises, for each frame of the image, generating a projection of the light-field image.

26. A system for animating presentation of an image, the system comprising:
a data store configured to receive the image;
a processor communicatively coupled to the data store, configured to:
automatically evaluate one or more attributes of the image;
based on the one or more attributes, automatically select a first animation parameter; and
generate an animation of the image such that the animation possesses the first animation parameter; and
a display device, communicatively coupled to the processor, configured to display the animation.

27. The system of claim 26, wherein the one or more attributes comprise a coloration of the image;
and wherein the processor is further configured to automatically evaluate the one or more attributes by:
dividing the image into a plurality of regions; and
assessing coloration of each of the regions.

28. The system of claim 26, wherein the one or more attributes comprise presence of a computer-recognizable feature in the image;
wherein the processor is further configured to automatically evaluate the one or more attributes by:
dividing the image into a plurality of regions; and
using at least one of color, texture, shape, and position of a first region of the plurality of regions to identify the computer-recognizable feature in the first region.

29. The system of claim 26, wherein the one or more attributes comprise presence of a computer-recognizable human face in the image;
and wherein the processor is further configured to automatically evaluate the one or more attributes by analyzing the computer-recognizable human face to assess an emotion expressed by the computer-recognizable human face.

30. The system of claim 26, wherein the one or more attributes comprise a gaze direction of a person appearing in the image;
wherein the processor is further configured to automatically evaluate the one or more attributes by:
identifying a pupil of the person; and
based on a location of the pupil relative to one or more other facial features of the person, assessing the gaze direction.

31. The system of claim 26, wherein the one or more attributes comprise a depth, relative to a camera used to capture the image, of an object appearing in the image;
wherein the image comprises a light-field image;
and wherein the processor is further configured to automatically evaluate the one or more attributes by using a depth map for the image, the depth map comprising the depth, to identify at least one significant spatial feature of the object.

32. The system of claim 26, wherein the processor is further configured to automatically select the first animation parameter by:
generating an emotion index indicative of an emotion conveyed by the image; and
using the emotion index to select the first animation parameter;
and wherein the first animation parameter comprises a tempo of the animation.

33. The system of claim 26, wherein the processor is further configured to generate the animation by generating a view of the image through a virtual camera;
and wherein the first animation parameter is selected from the group consisting of a change in an attribute of the virtual camera, and motion of the virtual camera.

34. The system of claim 26, wherein the image comprises a light-field image, and wherein the processor is further configured to generate the animation of the image by, for each frame of the image, generating a projection of the light-field image.
